(19) United States
(12) Patent Application Publication
(10) Pub. No.: US 2021/0345640 A1
(43) Pub. Date: Nov. 11, 2021

(54) ICE CREAM CONE DRIP CATCHER

(71) Applicant: Mickey MACDONALD, Bedford, Nova Scotia (CA)

(72) Inventor: Mickey MACDONALD, Bedford, Nova Scotia (CA)

(21) Appl. No.: 17/278,042

(22) PCT Filed: Sep. 20, 2019
(86) PCT No.: PCT/CA2019/000132

§ 371 Date: Mar. 19, 2021

(30) Foreign Application Priority Data
Sep. 25, 2018 (CA) 3,018,701

(51) Int. Cl. A23G 9/50

(52) U.S. Cl. CPC A23G 9/506; A23G 9/503

(57) ABSTRACT

An ice cream cone drip catcher including a trough adapted for surrounding an upper portion of an ice cream cone. The trough has an inside rim adapted for surrounding the upper portion of the ice cream cone in close proximity and an outside rim adapted for surrounding the upper portion of the ice cream cone at a predetermined distance such that ice cream drips from ice cream placed in the ice cream cone and extending upwardly and outwardly therefrom are captured therein. The drip catcher further includes a cone-interacting structure extending downwardly and inwardly from the inside rim.

### CROSS-REFERENCE TO RELATED APPLICATIONS

This application is the national stage filing of International Application No. PCT/CA2019/000132 (corresponding to International Publication No. WO 2020/061672) filed on Sep. 20, 2019, which claims priority to Canadian Patent Application No. 3,018,701, filed on Sep. 25, 2018. The entire contents of both of these applications are incorporated by reference herein.

### FIELD

The present invention relates to ice cream cones, and more particularly to an ice cream cone drip catcher for catching and collecting melting ice cream.

### BACKGROUND

Ice cream cones are frequently used as holders for ice cream—or other frozen dessert items such as, for example, frozen yogurt, sorbet, etc. all of which will be referred to as “ice cream” from hereon—which allow the user to consume the ice cream without a bowl or spoon and are typically made of an edible wafer-type or waffle-type material.

A frequent problem encountered when eating an ice cream cone is that the ice cream tends to melt faster than the user is able to consume it and, consequently, drips down onto the consumer's hand and clothes as wells as onto surroundings such as, for example, furniture and floor. For many years consumers as well as commercial ice cream vendors such as, for example, ice cream parlors and fast food restaurants, have encountered this problem.

The most common solution is for the consumer to wrap a paper napkin around the ice cream cone. Unfortunately, the paper napkin typically obstructs the access to the ice cream to some extent, thus reducing the consumer's pleasure while still not providing adequate protection.

Commercial products for solving this problem are re-usable ice cream cone holders/drip catchers that are made of a plastic or silicone material that cover the entire cone. Unfortunately, these re-usable holders are large and bulky, making it difficult to eat the ice cream, as well as making it impossible for transport and storage in a commercial environment.

It may be desirable to provide an ice cream cone drip catcher that substantially protects the user and surroundings from ice cream drips without obstructing access to the ice cream.

It also may be desirable to provide an ice cream cone drip catcher that enables the user to drink the collected melted ice cream.

It also may be desirable to provide an ice cream cone drip catcher that is simple and cost-effective to manufacture.

It also may be desirable to provide an ice cream cone drip catcher that is stackable and requires sufficiently small space for storage and transport in a commercial environment.

### SUMMARY

Accordingly, in one case, one object of the present invention is to provide an ice cream cone drip catcher that substantially protect the user and surroundings from ice cream drips without obstructing access to the ice cream.

In one case, another object of the present invention is to provide an ice cream cone drip catcher that enables the user to drink the collected melted ice cream.

In one case, another object of the present invention is to provide an ice cream cone drip catcher that is simple and cost-effective to manufacture.

In one case, another object of the present invention is to provide an ice cream cone drip catcher that is stackable and requires sufficiently small space for storage and transport in a commercial environment.

According to one aspect of the present invention, there is provided an ice cream cone drip catcher. The ice cream cone drip catcher comprises a trough adapted for surrounding an upper portion of an ice cream cone. The trough has an inside rim adapted for surrounding the upper portion of the ice cream cone in close proximity and an outside rim adapted for surrounding the upper portion of the ice cream cone at a predetermined distance such that ice cream drips from ice cream placed in the ice cream cone and extending upwardly and outwardly therefrom are captured therein. A cone-interacting structure extending downwardly and inwardly from the inside rim.

According to one aspect of the present invention, there is provided an ice cream cone drip catcher. The ice cream cone drip catcher comprises a ring-shaped trough adapted for surrounding an upper portion of an ice cream cone. The trough has an inside rim adapted for surrounding the upper portion of the ice cream cone in close proximity and an outside rim adapted for surrounding the upper portion of the ice cream cone at a predetermined distance such that ice cream drips from ice cream placed in the ice cream cone and extending upwardly and outwardly therefrom are captured therein. A cone-interacting structure extending downwardly and inwardly from the inside rim at a substantially same angle as the ice cream cone. The drip catcher is shaped such that a plurality of the same are stackable.

According to one aspect of the present invention, there is provided an ice cream cone drip catcher. The ice cream cone drip catcher comprises a ring-shaped trough adapted for surrounding an upper portion of an ice cream cone. The trough has an inside rim adapted for surrounding the upper portion of the ice cream cone in close proximity and an outside rim adapted for surrounding the upper portion of the ice cream cone at a predetermined distance such that ice cream drips from ice cream placed in the ice cream cone and extending upwardly and outwardly therefrom are captured therein. A cone-interacting structure extending downwardly and inwardly from the inside rim at a substantially same angle as the ice cream cone. The drip catcher made from a single sheet of foldable material.

An advantage of the present invention is that it provides an ice cream cone drip catcher that substantially protect the user and surroundings from ice cream drips without obstructing access to the ice cream.

A further advantage of the present invention is that it provides an ice cream cone drip catcher that enables the user to drink the collected melted ice cream.

A further advantage of the present invention is to provide an ice cream cone drip catcher that is simple and cost-effective to manufacture.

A further advantage of the present invention is to provide an ice cream cone drip catcher that is stackable and requires sufficiently small space for storage and transport in a commercial environment.

### BRIEF DESCRIPTION OF THE DRAWINGS

An embodiment of the present invention is described below with reference to the accompanying drawings, in which:

FIGS. 1a to 1d are simplified block diagrams illustrating a side view, a top view, a bottom view, and a cross-sectional view, respectively, of an ice cream cone drip catcher according to an embodiment of the invention;

FIG. 2 is a simplified block diagram illustrating a top view of a paper-cutout for manufacturing the ice cream cone drip catcher according to an embodiment of the invention;

FIG. 3 is a simplified block diagram illustrating a cross-sectional view of a rim structure of the ice cream cone drip catcher according to an embodiment of the invention;

FIGS. 4a and 4b are simplified block diagrams illustrating cross-sectional views of two different shapes of the trough of the ice cream cone drip catcher according to an embodiment of the invention; and,

FIG. 5 is a simplified block diagram illustrating a cross-sectional view of a stack of the ice cream cone drip catchers according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

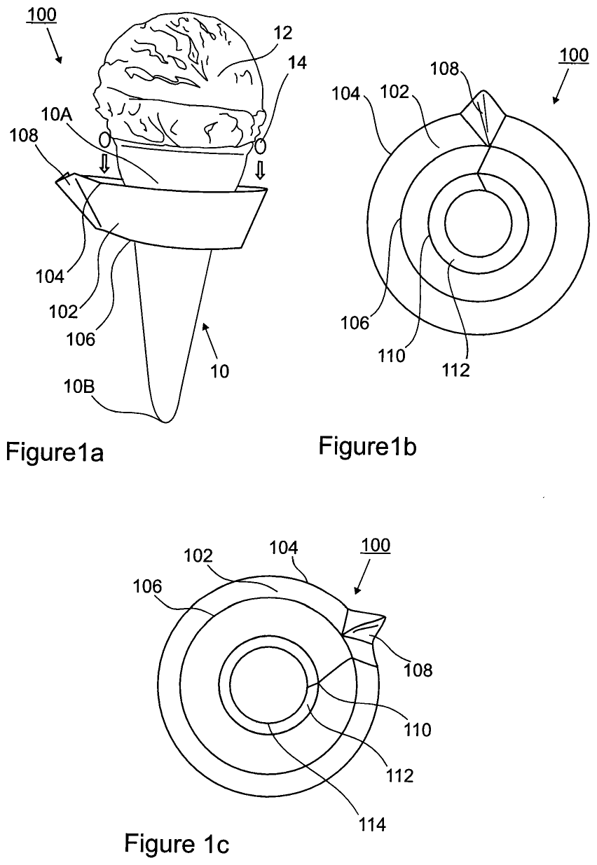

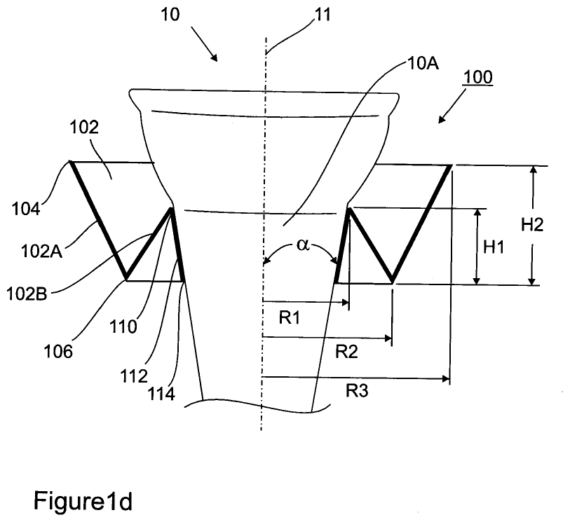

Referring to FIGS. 1a to 1d an ice cream cone drip catcher 100 according to an embodiment of the invention is provided. The ice cream cone drip catcher 100 comprises a ring-shaped trough 102 surrounding an upper portion 10A of an ice cream cone 10. The trough 102 has an inside rim 110 surrounding the upper portion 10A of the ice cream cone 10 in close proximity—radius R1 from central axis 11—and an outside rim 104 surrounding the upper portion of the ice cream cone 10 at a predetermined distance—radius R3 from the central axis 11—such that ice cream drips 14 from ice cream 12 placed in the upper portion 10A of the ice cream cone 10, and extending upwardly and outwardly therefrom, are captured therein, as illustrated in FIG. 1a. Cone-interacting structure 112 extends downwardly and inwardly from the inside rim 110 to bottom edge 114.

The cone-interacting structure 112 can be oriented at a substantially same angle α the ice cream cone 10 is tapering towards the bottom end 10B to provide a substantially snug fit when the ice cream cone drip catcher 100 is placed on the upper portion 10A of the ice cream cone 10, as illustrated in FIG. 1a.

The downward extension of the cone-interacting structure 112 from the inside rim 110 is determined such that a sufficient seal for preventing melted ice cream accumulated in the trough 102 from escaping between the cone-interacting structure 112 and the upper portion 10A of the ice cream cone 10 is provided. For example, the downward extension is determined such that the bottom end of the cone-interacting structure 112 is at a same level as bottom 106 of the trough 102—thus maximizing the length of the cone-interacting structure 112 while at a same time minimizing the space required for stacking the ice cream cone drip catcher 100, as will be described hereinbelow—but is not limited thereto. Optionally, an additional folded layer is disposed on the inside of the cone-interacting structure 112 and adhered thereto (not shown) to further improve the fit.

The ice cream cone drip catcher 100 is easily applied by inserting the bottom end 10B of the ice cream cone 10 into the opening surrounded by the cone-interacting structure 112 and then moving the ice cream cone drip catcher 100 upwards along axis 11 until the cone-interacting structure 112 is interacting with the upper portion 10A of the ice cream cone 10 in a substantially snug fit.

The trough 102 can comprise: outside wall 102A extending substantially straight downwardly and inwardly from the outside rim 104 to the bottom 106; and, inside wall 102B extending substantially straight upwardly and inwardly from the bottom 106 to the inside rim 110, enabling manufacturing of the ice cream cone drip catcher 100 by folding a single sheet of foldable material such as, for example, paper, as will be described hereinbelow.

The outside rim 104—height H2 above the bottom 106—is placed above the inside rim 110—height H1 above the bottom 106—a predetermined distance—H2-H1—thereto. The dimensions—radii R1 to R3; heights H1 & H2; and angle α—of the ice cream cone drip catcher 100 are determined in dependence upon the dimensions and shape of the ice cream cone 10 such that: the same substantially snugly fits to the upper portion 10A of the ice cream cone 10; substantially all ice cream drips 14 are caught; a sufficient amount of melted ice cream can be collected without overflowing or spilling; the ice cream 12 can easily be eaten without obstruction; and, a user is able to drink the melted ice cream. As is evident, the dimensions of the ice cream cone drip catcher 100 are easily adapted to fit various types and sizes of ice cream cones.

Optionally, drinking spout 108 is disposed in the outside wall 102A of the trough 102 for facilitating drinking of the melted ice cream accumulated in the trough 102.

Further optionally, text, images, and/or patterns may be disposed onto the ice cream cone drip catcher 100, for example, onto the outside of the trough 102, but not limited thereto. For example, a commercial ice cream vendor may place its logo thereon for advertisement.

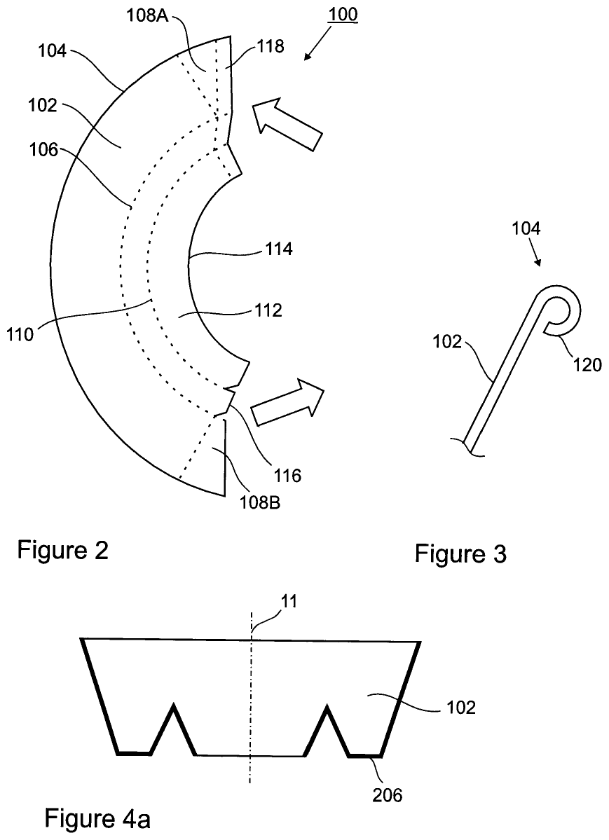

Referring to FIG. 2, the ice cream cone drip catcher 100 can be manufactured by folding a single sheet of foldable material such as, for example, food and liquid safe compostable paper. The outline of the ice cream cone drip catcher 100—trough 102, cone-interacting structure 112, spout 108A, 108B—plus overlap forms a section of an annulus between two arcs forming the edges 104 and 114 and two ends 116 and 118. After cutting along the outline, the paper-cutout is folded about the folding lines—indicated as dashed lines in FIG. 2—which will form the bottom 106, the inside rim 110, and the spout 108—with the ends 116 and 118 being moved towards each other during the folding, as indicated by the block arrows, and glued together. The folding lines can be stamped or scored into the paper to facilitate the folding process. This process provides a simple and cost-effective way of manufacturing the ice cream cone drip catcher 100.

Alternatively, the ice cream cone drip catcher 100 may be manufactured by combining separate strips of a flexible sheet material such as, for example, paper, together with one strip forming one of: the outside wall 102A; the inside wall 102B; and, the cone-interacting structure 112.

Optionally, the outside rim 104 is provided as a rolled rim 120, as illustrated in FIG. 3.

Alternatively, the ice cream cone drip catcher 100 is made of a non-foldable material such as, for example, an edible waffle or wafer material using a conventional molding process used for manufacturing ice cream cones, enabling the user to eat the ice cream cone drip catcher 100 together with the ice cream cone.

Further alternatively, the ice cream cone drip catcher 100 is made of a food and liquid safe plastic material using a conventional plastic molding process, thus providing a re-usable ice cream cone drip catcher 100 for, for example, home use.

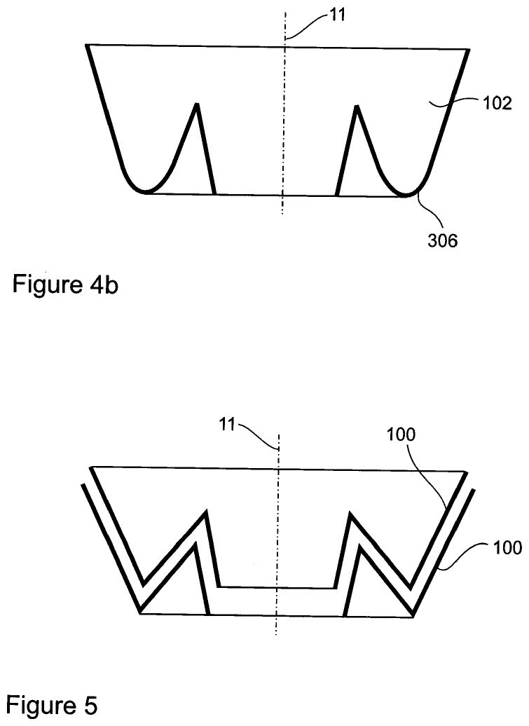

Optionally, the trough 102 may be provided having different cross-sectional shapes such as, for example, a flat bottom 206, as illustrated in FIG. 4a, or a rounded bottom 306, as illustrated in FIG. 4b. Further optionally, the trough 102 is other than ring-shaped such as, for example, having a polygon-shaped bottom and/or outside wall.

Referring to FIG. 5, the ice cream cone drip catcher 100 is, in one case, shaped such that a plurality of the same are stackable along the axis 11 in order to reduce the space used for storing and transporting the same in a commercial environment.

The present invention has been described herein with regard to certain embodiments. However, it will be obvious to persons skilled in the art that a number of variations and modifications can be made without departing from the scope of the invention as described herein.

What is claimed is:

1. An ice cream cone drip catcher comprising:
a trough adapted for surrounding an upper portion of an ice cream cone, the trough having an inside rim adapted for surrounding the upper portion of the ice cream cone in close proximity and an outside rim adapted for surrounding the upper portion of the ice cream cone at a predetermined distance such that ice cream drips from ice cream placed in the ice cream cone and extending upwardly and outwardly therefrom are captured therein; and,
a cone-interacting structure extending downwardly and inwardly from the inside rim.

2. The drip catcher according to claim 1 wherein the trough is ring-shaped.

3. The drip catcher according to claim 1 wherein the cone-interacting structure is oriented at a substantially same angle as the ice cream cone.

4. The drip catcher according to claim 1 wherein the outside rim is placed a predetermined distance above the inside rim.

5. The drip catcher according to claim 1 comprising a spout disposed in an outside portion of the trough.

6. The drip catcher according to claim 2 wherein the drip catcher is made from a single sheet of foldable material.

7. The drip catcher according to claim 6 wherein the single sheet of foldable material comprises folding lines disposed therein.

8. The drip catcher according to claim 1 wherein the drip catcher is made of a paper product.

9. The drip catcher according to claim 1 wherein the outside rim is a rolled rim.

10. The drip catcher according to claim 1 wherein the drip catcher is stackable.

11. The drip catcher according to claim 1 wherein the drip catcher is made of an edible material.
